(19) United States
(12) Patent Application Publication
(10) Pub. No.: US 2017/0339642 A1
(43) Pub. Date: Nov. 23, 2017

(54) METHOD AND SYSTEM FOR PROXIMITY DETECTION OF MOBILE DEVICES FOR BATTERY PRESERVATION AND LOCALIZED COMMUNICATION

(71) Applicant: Outsite Networks, Inc., Norfolk, VA (US)

(72) Inventor: Anton Bakker, Norfolk, VA (US)

(73) Assignee: Outsite Networks, Inc., Norfolk, VA (US)

(21) Appl. No.: 15/594,000

(22) Filed: May 12, 2017

Related U.S. Application Data
(60) Provisional application No. 62/338,099, filed on May 18, 2016.

(51) Int. Cl. H04W 52/02; H04W 4/00; H04W 8/00; H04B 5/00

(52) U.S. Cl. CPC H04W 52/0229; H04W 52/0235; H04B 5/0012; H04W 4/008; H04W 8/005

(57) ABSTRACT

A system, method, and computer program for detecting proximity of a mobile device, including a circuit configured to detect proximity of a mobile device, and when detection occurs, enable a beacon circuit to wake up and advertise a presence. The circuit including a proximity sensor circuit; a wake signal generated by the proximity sensor circuit when the mobile device has been detected; and a beacon circuit, normally in a low power, non-communicating state, and while activated by the wake signal advertises a presence of the beacon circuit for a predetermined amount of time, after which the beacon circuit returns to a low power, non-communicating state.

### CROSS REFERENCE TO RELATED DOCUMENTS

The present invention claims priority to U.S. Provisional Patent Application Ser. No. 62/338,099 of Anton BAKKER, entitled “METHOD AND SYSTEM FOR PROXIMITY DETECTION OF MOBILE DEVICES FOR BATTERY PRESERVATION AND LOCALIZED COMMUNICATION,” filed on May 18, 2016, now pending, the entire disclosure of which is hereby incorporated by reference herein.

### BACKGROUND OF THE INVENTION

### Field of the Invention

This invention relates generally relates to systems and methods for detecting and communicating information between two devices, and more particularly to a system and method for proximity detection of a mobile devices for battery preservation, localized communications, and the like.

### Discussion of the Background

In recent years, systems and methods employing Bluetooth Low Energy (BLE) devices, such as beacons (e.g., Apple iBeacons), and the like, have been developed and which are normally battery operated devices used to advertise general location and status information, and the like. In addition, applications have been developed that use such devices for more precise positional detection, such as determining that a mobile device is within a few inches of the beacon, and the like. However, such methods and systems lack robustness with respect preserving the battery life, and the like, of such beacon devices.

### SUMMARY OF THE INVENTION

Therefore, there is a need for a method and system that addresses the above and other problems with conventional systems and methods employing Bluetooth Low Energy (BLE) devices, such as beacons (e.g., Apple iBeacons), and the like. The above and other problems are addressed by the illustrative embodiments of the present invention, which provide a method and system including being able to detect and communicate with a mobile device in such a way as to preserve beacon battery life and to enhance the mobile device's ability to determine its position relative to the beacon. For example, a circuit can be configured such that a beacon will not advertise its location until it detects a mobile device in its proximity, saving considerable battery life. Furthermore, as the mobile device is known to be in close proximity, the beacon can significantly reduce its signal strength, again increasing battery life, such that mobile devices outside of the beacon's proximity will have difficulty in receiving, for example, content including lower power advertisements, data, information, and the like. The mobile device, receiving such advertisement message from the beacon will know that it is in close proximity to such specific beacon.

Accordingly, in illustrative aspects of the present invention there is provided a system, method, and computer program for detecting proximity of a mobile device, including a circuit configured to detect proximity of a mobile device, and when detection occurs, enable a beacon circuit to wake up and advertise a presence. The circuit including a proximity sensor circuit; a wake signal generated by the proximity sensor circuit when the mobile device has been detected; and a beacon circuit, normally in a low power, non-communicating state, and while activated by the wake signal advertises a presence of the beacon circuit for a predetermined amount of time, after which the beacon circuit returns to a low power, non-communicating state.

The proximity sensor includes a near field communication (NFC) field sensor configured to detect an NFC field emitted by the mobile device.

The proximity sensor includes a capacitive proximity sensor including a capacitive plate and a local ground reference forming a capacitor; and a capacitive proximity circuit that uses the capacitor to create an electrical field, and configured to detect an alteration of a dielectric changing capacitance indicating that the mobile device has entered the electrical field.

The beacon circuit is configured to allow bidirectional communications with the mobile device.

The beacon circuit, once activated by the wake signal, stops advertising a presence of the beacon circuit after concluding communications with the mobile device and returns to a low power, non-communicating state.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an illustrative system wherein a circuit provides proximity sensing to a beacon device; and

FIG. 2 is an illustrative flowchart wherein a circuit provides proximity sensing to a beacon device.

### DETAILED DESCRIPTION OF THE PREFERRED EMBODIMENTS

Generally, the systems and methods of the present invention can include circuits configured to allow beacons, such as Bluetooth Low Energy (BLE) devices (e.g., Apple iBeacons), and the like, to not only preserve battery life but also to assist a mobile phone device in determining its relative position, and the like, to a beacon device. In an illustrative embodiment, a smart phone application can be configured to provide information, services, and the like, to a mobile phone user relative to its position in a department store, convenience store, gas station, and the like. Such information can depend on which isle or even shelf the owner is near. Other applications can be configured to provide an opportunity for discounting or other incentives when the owner is detected making purchases at a Point of Sale (POS) register, and the like. Such beacons can operate by emitting periodic messages, and the like, identifying themselves. For example, a particular location (e.g., a department store, gas station, convenience store, and the like) can often include several beacons. More specifically, a gas station can include a beacon placed at each fueling dispenser, each Point of Sale (POS) register, and the like. Similarly, a grocery store can include beacons located near items with special discounts, and the like.

In this respect, a mobile device can be configured to receive advertisement messages, incentives, and the like, from several beacons at various locations, and if predetermined conditions are met, can receive messages from beacons at other, nearby, locations. However, a mobile application that wishes to provide specific information based on the nearest beacon may have difficulties in determining which of the several beacon sources are closest to the device. Furthermore, it is often desirable to know when the mobile device is within a few feet or even a few inches of the beacon device. For example, a mobile application may employ a user presenting a mobile device to a beacon in order to trigger a specific action, and the like. In this way, the user can request or receive information by presenting the device within inches or even a fraction an inch to the beacon, essentially “tapping” the beacon with the device. Such action by the user can be construed a request for some appropriate action, such as providing nutritional information about a specific product in a grocery store, identifying the owner to a POS, loyalty or discounting system, providing an audio track to correspond with, for example, a historical display on a walking tour, and the like.

In addition, if a specific beacon can be determined, the mobile device may desire to connect directly to the beacon in order to transfer information in either direction. For example, the beacon may provide additional information (e.g., a Web Uniform Resource Locator (URL)) that is not otherwise present in the regular beacon advertisement. Additionally, the application may employ the ability to connect directly to the beacon in order to configure items, such as the URL, Beacon ID, power levels, and the like.

Presently, mobile devices typically only have access to messages transmitted by a beacon. In this respect, to determine relative position or closeness, mobile devices tend to rely on inaccurate sources of position, such as a Received Signal Strength Indicator (RSSI), and the like. Once an RSSI is determined, the mobile device can attempt to calculate a probable distance to the RSSI source. However, RSSI is not very reliable, as there can be many noise sources that can affect its value, such as line-of-sight obstructions, other radio signals, and the like.

To combat RSSI reliability issues, mobile devices will often measure RSSI values across several beacon advertisements, averaging a value. While this provides a slightly more accurate RSSI value, there are two main problems. First, although the RSSI value is more consistent, it is still subject to many noise sources and interfere that can easily allow a beacon further away to provide a higher RSSI value. Second, averaging RSSI values takes time. In order for an average of, for example, five messages, to be used, the mobile device needs to wait until five messages are received. Accordingly, fast advertising is essential for determining an RSSI value in a time-efficient manner. At the same time, a battery operated beacon only has a certain amount of power at its disposal, and is often expected to operate for months at a time. Higher advertising rate require a much higher power consumption rate, significantly reducing available life. Accordingly, the systems and methods of the present invention provide for proximity detection of a mobile devices for battery preservation, localized communications, and the like.

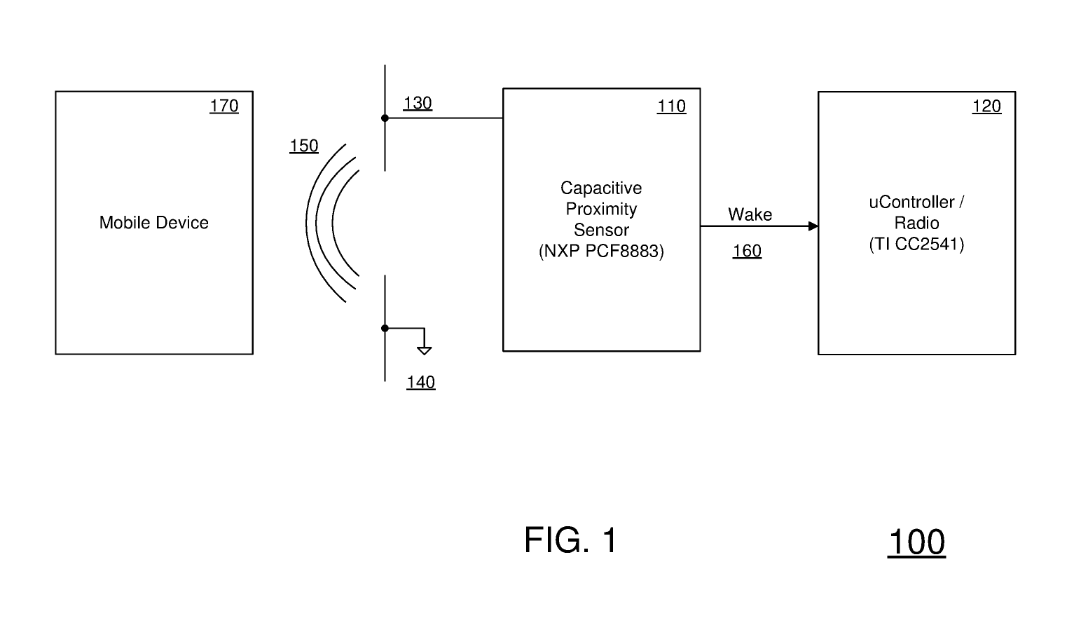

Referring now to the drawings and more particular to FIG. 1 thereof, there is illustrated a beacon with proximity sensing system 100. In FIG. 1, the system 100 includes a Microcontroller/Radio 120, and a proximity sensing circuit including a Capacitor Plate 130, a Local Ground Reference 140, and a Capacitive Proximity Sensor 110 that receives signals from the Capacitor Place 130 and can provide a Wake Signal 160 to the Microcontroller/Radio 120. The Capacitive Plate 130 forms a capacitance with the Local Ground Reference 140, generating an Electrical Field 150.

FIG. 1 also includes a Mobile Device 170 that, when placed within the Electrical Field 150, alters the dielectric, changing the capacitance measured by the Capacitive Proximity Sensor 110 that then generates a Wake Signal 160 to activate the Microcontroller/Radio 120 to enable communications until such time that the Mobile Device 170 leaves the Electrical Field 150, a predetermined amount of time elapses, communications with the Mobile Device 170 have concluded, or the Wake Signal 160 is de-asserted.

In the absence of an asserted Wake Signal 160, or if communications have been disabled due to the Mobile Device 170 leaving the Electrical Field 150, a predetermined amount of time elapsing, or communications with the Mobile Device 170 having concluded, the Microcontroller 120 returns to a low-power state, preserving battery life. In further illustrative embodiments, the Capacitive Proximity Sensor 110 need not be employed to detect the presence of the mobile device 170. For example, instead of the Capacitive Proximity Sensor 110, the detection of the presence of a Near Field Communications (NFC) energizing field, generated by a mobile device, and the like, can be employed, as will be appreciated by those of ordinary skill in the relevant art(s), based on the teachings of the present disclosure.

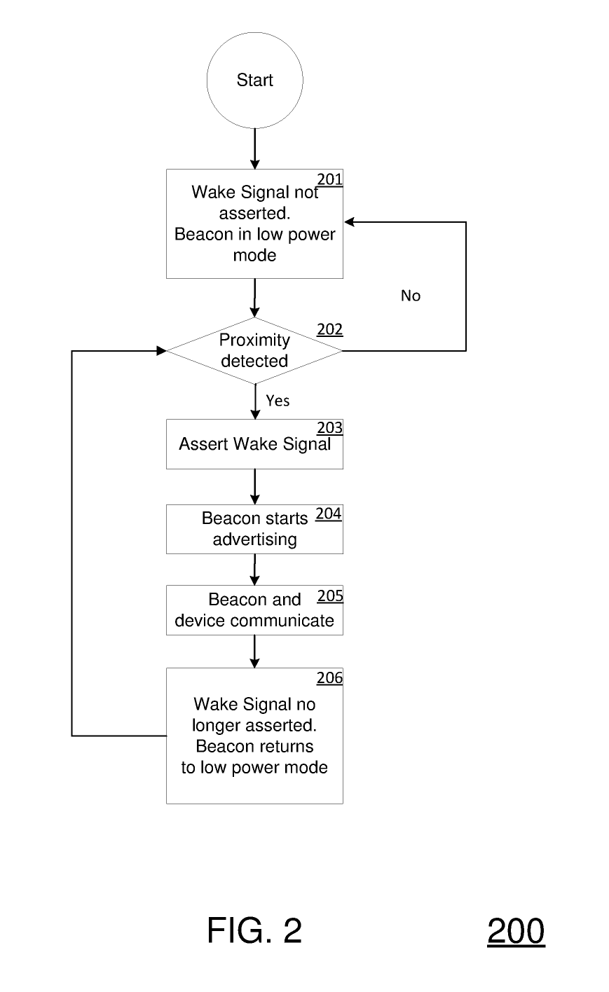

FIG. 2 is an illustrative flowchart wherein a circuit provides proximity sensing to a beacon device. In FIG. 2, the Wake Signal 160 is initially not asserted and the Microcontroller/Radio 120 is in a low power state in step 201. When a Mobile Device 170 is placed within the Electrical Field 150, altering the dielectric and changing the capacitance measured by the Capacitive Proximity Sensor 110, step 202 determines that the Mobile Device 170 is within proximity and asserts the Wake Signal 160 in step 203, causing the Microcontroller/Radio 120 to exit its low power state and start advertising.

In step 205, the Microcontroller/Radio 120 and the Mobile Device 170 communicate and, when communications have completed, the Wake Signal 160 is no longer asserted, and the Microcontroller/Radio 120 returns to a low power mode in step 206, returning to wait for proximity detection in step 202.

The above-described devices and subsystems of the illustrative embodiments can include, for example, any suitable servers, workstations, PCs, laptop computers, microcomputers, microcontrollers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, flash memory, SSD, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, integrated development environment, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for detecting proximity of a mobile device, the system comprising:
a proximity circuit configured to detect proximity of a mobile device, and when detection occurs, enable a beacon circuit to wake up and advertise a presence, the proximity circuit comprising:
a proximity sensor circuit;
a wake signal generated by the proximity sensor circuit when the mobile device has been detected; and
a beacon circuit, normally in a low power, non-communicating state, and while activated by the wake signal advertises a presence of the beacon circuit for a predetermined amount of time, after which the beacon circuit returns to a low power, non-communicating state.

2. The system of claim 1, wherein the proximity sensor comprises:
a near field communication (NFC) field sensor configured to detect an NFC field emitted by the mobile device.

3. The system of claim 1, wherein the proximity sensor comprises:
a capacitive proximity sensor including a capacitive plate and a local ground reference forming a capacitor; and
a capacitive proximity circuit that uses the capacitor to create an electrical field, and configured to detect an alteration of a dielectric changing capacitance indicating that the mobile device has entered the electrical field.

4. The system of claim 1, wherein the beacon circuit is configured to allow bidirectional communications with the mobile device.

5. The system of claim 1, wherein the beacon circuit, once activated by the wake signal, stops advertising a presence of the beacon circuit after concluding communications with the mobile device and returns to a low power, non-communicating state.

6. A method for detecting proximity of a mobile device, the method comprising:
detecting with a proximity circuit proximity of a mobile device, and when detection occurs, enable a beacon circuit to wake up and advertise a presence, the circuit comprising
generating with a proximity sensor circuit of the proximity circuit a wake signal when the mobile device has been detected; and
with a beacon circuit of the proximity circuit, normally in a low power, non-communicating state, and while activated by the wake signal, advertising a presence of the beacon circuit for a predetermined amount of time, after which the beacon circuit returns to a low power, non-communicating state.

7. The method of claim 6, wherein the proximity sensor comprises:
a near field communication (NFC) field sensor configured to detect an NFC field emitted by the mobile device.

8. The method of claim 6, wherein the proximity sensor comprises:
a capacitive proximity sensor including a capacitive plate and a local ground reference forming a capacitor; and
a capacitive proximity circuit that uses the capacitor to create an electrical field, and configured to detect an alteration of a dielectric changing capacitance indicating that the mobile device has entered the electrical field.

9. The method of claim 6, further comprising allowing with the beacon circuit bidirectional communications with the mobile device.

10. The method of claim 6, further comprising with the beacon circuit, once activated by the wake signal, stopping advertising a presence of the beacon circuit after concluding communications with the mobile device and returns to a low power, non-communicating state.

11. A computer-readable storage medium for storing computer-executable instructions that, when executed, perform a method for detecting proximity of a mobile device, comprising the steps of:
detecting with a proximity circuit proximity of a mobile device, and when detection occurs, enable a beacon circuit to wake up and advertise a presence, the circuit comprising
generating with a proximity sensor circuit of the proximity circuit a wake signal when the mobile device has been detected; and
with a beacon circuit of the proximity circuit, normally in a low power, non-communicating state, and while activated by the wake signal, advertising a presence of the beacon circuit for a predetermined amount of time, after which the beacon circuit returns to a low power, non-communicating state.

12. The computer-readable storage medium of claim 11, wherein the proximity sensor comprises:
a near field communication (NFC) field sensor configured to detect an NFC field emitted by the mobile device.

13. The computer-readable storage medium of claim 11, wherein the proximity sensor comprises:
a capacitive proximity sensor including a capacitive plate and a local ground reference forming a capacitor; and
a capacitive proximity circuit that uses the capacitor to create an electrical field, and configured to detect an alteration of a dielectric changing capacitance indicating that the mobile device has entered the electrical field.

14. The computer-readable storage medium of claim 11, further comprising allowing with the beacon circuit bidirectional communications with the mobile device.

15. The computer-readable storage medium of claim 11, further comprising with the beacon circuit, once activated by the wake signal, stopping advertising a presence of the beacon circuit after concluding communications with the mobile device and returns to a low power, non-communicating state.
